(19) United States
(12) Patent Application Publication
(10) Pub. No.: US 2022/0087222 A1
(43) Pub. Date: Mar. 24, 2022

(54) PET BALL THROWING TOY SET

(71) Applicant: Graham Geil Wilson, Denver, CO (US)

(72) Inventor: Graham Geil Wilson, Denver, CO (US)

(21) Appl. No.: 16/525,300

(22) Filed: Jul. 29, 2019

(51) Int. Cl. A01K 15/02

(52) U.S. Cl. CPC A01K 15/025

(57) ABSTRACT

The invention relates to a novel pet ball throwing toy that has proprietary balls designed to rub against one side of a blade with teeth in it to create a zipping sound when the pet owner flings the blade forward to release the balls. The apertures in the balls have a beveled edge to create a loud enough zipping noise to entice the pet.

### FIELD

The invention relates to a novel pet toy wherein a ball throwing device uses a curved throw stick with teeth on one side to launce the inventive ball, or multiple balls to launch and create a “zipping sound” as the ball(s) traverse the length of the throw stick (hereinafter Zipstick), and travel through the air for a pet to retrieve.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel ball throwing set comprising a launching blade and ball set that launches balls for a pet to fetch while creating an intriguing zipping sound as the ball(s) launch. The ball(s) with the set are designed with apertures that allow a user to stick the tip of the Zipstick through an aperture and easily pick the ball(s) up. The ball will travel to the hand end of the Zipstick and is ready to be launched again.

The inventive launcher is constructed in plastic with a molded tapered handle and blade similar in shape to a toy sword, wherein the handle and blade are a single molded piece. The handle provides comfortable ergonomic grip for the user, and the “blade” of the Zipstick has small teeth cut into one edge of the blade to create the “zipping” sound when a ball is launched therefrom.

### SUMMARY, OBJECTS AND ADVANTAGES

The inventive set contains one ball, but additional balls are available specifically for the inventive set. The apertures in the balls are designed to allow them to be picked up easily by a user simply inserting the blade tip into an aperture and lift up on the Zipstick. The ball will travel toward the handle and be ready to be launched when a user throws the Zipstick forward. The outer edges of the balls are tapered or beveled so they are more malleable than the rest of the ball to allow the zipping sound to be loud enough to entice the pet.

As one or more balls traverse the length of the blade when a user applies the throwing motion, the aperture edges rub along the length of teeth on one side of the blade, creating a “zipping” sound to intrigue the pet. The smooth side of the blade aids in the ability for the balls to be launched even while contacting the side of the blade with teeth.

Once launched, one or more balls are retrieved by the pet, and are malleable yet durable so that the pet can grasp the ball by using one of the apertures on the ball so it is easy for the pet to carry and return to the user.

### BRIEF DESCRIPTION OF THE DRAWINGS

The invention is described in further detail by reference to the drawings in which:

FIG. 1; shows the ball thrower set; and

FIG. 2; is a magnified view of the blade portion of the ball throwing set.

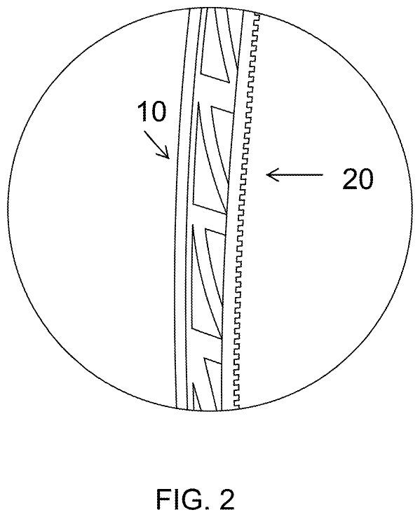

### DETAILED DESCRIPTION, INCLUDING BEST MODES OF CARRYING OUT THE INVENTION

The following detailed description illustrates the invention by way of example, not by way of limitation of the principles of the invention. This description will clearly enable one skilled in the art to make and use the invention, and describes various embodiments, adaptations, variations, alternatives, and uses of the invention. The description includes what are presently believed to be the best modes of carrying out the invention.

In this regard, the invention is illustrated in two relatively simple figures; although sufficiently complex as to illuminate to one skilled in the art of such manufacturing and design, a viable method for making or using said invention.

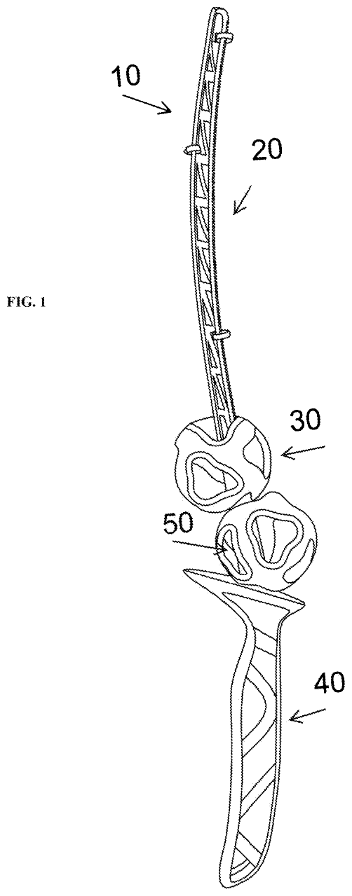

FIG. 1 shows the complete ball throwing set. The smooth portion of the blade 10 is located down the entire length of the blade. The opposite side of the blade 20 shows the teeth which run along the opposite side of the blade. The proprietary balls are shown in rest on the blade 30. Once a user uses arcs back and then with a forward motion, the balls will travel the length of the blade and contact the teeth on one side of the blade and create a zipping sound as the ball launches off the tooth edge of the blade. An ergonomic handle 40 is located at the end of the blade piece and is a single-mold piece. Illustrated by bold line are the inside edges of the balls 50. While it may not translate well in B&W line drawings emphasis is placed on the inner edges of the ball apertures as they are slightly thinner or beveled so that they are malleable when they contact the toothed edge of the blade, and when thrown, magnifies the zipping sound.

1) A pet ball throwing toy comprising:
a) a tapered handle with grip
b) a curved blade with teeth on one edge of the blade and smooth on the opposite side
c) proprietary balls to the thrower that contain apertures in the ball for travel along the blade edge and result in creating a zipping sound when the balls are launched by forward motion by a user.

2) The pet ball throwing toy of claim 1 wherein the tapered handle is ergonomically appropriate for comfort of a user, and wherein the tapered handle is a single piece molded to include the curved blade in a single piece.

3) The pet ball throwing toy of claim 1 wherein the curved blade is a single piece molded with the handle wherein one edge of the blade portion contains a row of teeth notched into the blade along a throwing section and wherein the teeth will create a zipping sound as a ball is launched from the blade.

4) The pet ball throwing toy on claim 1 wherein one edge of the blade is smooth and provides less friction than the edge with the teeth so that the ball may physically be launchable from the blade.

4) The pet ball throwing toy of claim 1 wherein a single piece molded ball apertures within it designed for the launcher's blade to fit in a proximity that allows the zipping sound to be heard when the ball is launched from the blade, and wherein the outer edges of the apertures are slightly thinner, or beveled so that they are malleable and enhance the zipping sound when the ball traverses the blade.
